(19) United States
(12) Patent Application Publication
(10) Pub. No.: US 2007/0101188 A1
(43) Pub. Date: May 3, 2007

(54) Method for establishing stable storage mechanism

(75) Inventor: Wen-Hua Lin, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/387,231

(22) Filed: Mar. 22, 2006

(30) Foreign Application Priority Data
Oct. 31, 2005 (TW) 094138048

(51) Int. Cl. G06F 11/00

(52) U.S. Cl. 714/6

(57) ABSTRACT

A method for establishing a stable storage mechanism applicable to a computer device with a RAID array and a RAID control unit is proposed. Operating conditions of the disks are constantly monitored, and if a disk is suspected to fail in the near future, a warning message is outputted to actuate a dynamic mirroring procedure so as to backup data stored in that disk to a redundant disk dynamically created.

### BACKGROUND OF THE INVENTION

1. Field of the Invention

The present invention relates generally to a data protecting technology, more particularly, to a method for establishing a stable storage mechanism that dynamically activates a data protection mechanism when an abnormal situation is detected in a disk of a RAID (Redundant Array of Independent Disks) system.

2. Description of Related Art

With the rapid development of information technology, storage devices with large storage capacity are in high demand. In order to increase the storing capacity per unit area, storage devices have been evolved from the traditional tape drives to present hard disk drives, in which the storage capacity of a single hard disk drive has also increased from MBs (MegaByte) to GBs (GigaByte), providing users with more storage capacity per unit area for storing more data such as texts, images, movies and the like. However, the more data that can be stored per unit area, the more severe the extent of damage is, especially for enterprises and government agencies, such damage may cause significant economic loss.

In order to avoid the above issue and enhance efficiency of disk drives, protecting and backup schemes has emerged, one of the scheme that is well known is called the RAID (Redundant Array of Independent Disks) system, which includes a plurality of disk drives and a RAID control unit. The RAID system has several storage modes, e.g., RAID 0, RAID 1, RAID 0+1, RAID 2, RAID 3, RAID 4, RAID 5, RAID 6, RAID 7, RAID 10, RAID 30 and RAID 50 and the like for reducing the influence of damage and increasing reliability.

With reference to FIG. 1A, shown is the RAID 0 (disk segmentation) mode of a RAID system 14, which stores data of a storage unit 13 composed of at least two disks. The merit of this mode is in that different data can be transmitted by the two disks, so as to upgrade the I/O access efficiency. Blocks of a data stream 11 are stripped across a first disk 131 and a second disk 132 via a RAID control unit 12. For example, ten blocks of data such as A, B, C, D, E, F, G, H, I and J included in the data stream 11 are written into the first and second disks 131 and 132 by the RAID control unit 12. As a result, five blocks A, C, E, G and I of the data stream 11 are stored in the first disk 131, while the other five blocks B, D, F, H and J are stored in the second disk 132. Thus, next time the data stream 11 is read, the complete data stream 11 will be provided through the first disk 131 and the second disk 132. However, if the second disk 132′ (as shown in FIG. 1B) is damaged, the complete data stream 11 cannot be provided, and the entire data in the RAID system 14′ is lost.

Since the above merely takes into account the I/O access efficiency, so RAID 1 (disk mirror) mechanism is then produced, which implements data backup (as shown in FIG. 2A) by storing the same piece of data into at least two disks of a storage unit 23 simultaneously. This RAID 1 mechanism allows data to be read and written normally even if one of the disks malfunctions by virtue of the mirroring technology. As shown in FIG. 2A, via a RAID control unit 22, each block of the data stream 21 is sequentially stored into both a first disk 231 and a second disk 232 composing a RAID system 24. For example, ten blocks of data such as A, B, C, D, E, F, G, H, I and J included in the data stream 21 are written into both the first and second disks 231 and 232 simultaneously by the RAID control unit 22. As a result, all ten blocks A, B, C, D, E, F, G, H, I and J of the data stream 21 are stored in the first disk 231, while the same blocks A, B, C, D, E, F, G, H, I and J of the data stream 21 are stored in the second disk 232. Thus, next time the data stream 21 is read, the complete data stream 21 can be provided through either the first disk 231 or the second disk 232. If the second disk 232′ (as shown in FIG. 2B) is suspected to be damaged, the computer device will be run under an unsafe state, which is referred to as operation in a degraded mode, then, the complete ten blocks A, B, C, D, E, F, G, H, I and J of the data stream 21 are provided by the first disk 231, thereby avoiding data of the RAID system 24 being unavailable in the event of a disk failure. The second disk 232′ with fault in doubt is then replaced with a spare disk 232″ (as shown in FIG. 2C), so as to reduce the burden of the first disk 232. Next, RAID control unit 22 reads disk data that is in the first disk 231 but not the snare disk 232 into the spare disk 232 as well as parity block check, so as to rebuild the ten blocks A, B, C, D, E, F, G, H, I and J of data. At this time, rebuilding the data blocks to the spare disk 232″ will cause repeated I/O accesses, which may result in low efficiency and I/O resource waste.

Another RAID mode, a RAID 0+1 (as shown in FIG. 3A) combining RAID 1 with RAID 0, is further developed. This mode stores data into a storage unit 33 composed of at least four disks, where blocks of a data stream 31 is first interleaved and stored into a first disk 331 and a second disk 332 via a RAID control unit 32 (a RAID 0 array). Then, this RAID 0 array is mirrored using RAID 1 approach into a third disk 333 and a fourth disk 334 composing another RAID 0 array. For example, ten blocks of data A, B, C, D, E, F, G, H, I and J of the data stream 31 are striped across the two disks 331 and 332 of the first RAID 0 array, that is, five blocks A, C, E, G and I are stored into the first disk 331, while the other five blocks B, D, F, H and J are stored in the second disk 332. Meanwhile, the same five blocks A, C, E, G and I are mirrored in the third disk 333, and the other five blocks B, D, F, H and J are mirrored in the fourth disk 334. This allows the RAID 0+1 system to have redundancy (mirroring) while boosting performance (interleaving). If one of disks fails, say the third disk 333, it is replaced with a third backup disk 333′ by reading the combined data from the first disk 331 and the second disk 332 and performing parity block check with the third backup disk 333′ and the fourth disk 334 to rebuild blocks A, C, E, G and I in the backup disk 333′. During the rebuild of the backup disk 333′, the rest of the three disks need to be repeatedly accessed, thus reducing performance and wasting I/O resources.

Although the improved RAID 0+1 system structure not only increases the I/O transmission efficiency but also has redundancy, more storage devices are required (one disk is used in addition) Thus, yet another RAID mode, RAID 5 (as shown in FIG. 4A), is developed. The merit is in that the amount of the hardware can be reduced while providing data backup. This mode stores data into a storage unit 43 composed of at least three disks. Blocks of a data stream 41 are sequentially store via the RAID control unit 42 into a first disk 431, a second disk 432 and a third disk 433, wherein, parity block check is also added. For example, ten blocks A, B, C, D, E, F, G, H, I and J of the data stream 41 are stored, in which five blocks A, CD, E, G and IJ are stored in the first disk 431, another five blocks B, C, EF, H and I are stored in the second disk 432, yet another five blocks AB, D, E, GH and J are stored in the third disk 433, wherein, CD, IJ stored in the first disk 431, EF in the second disk 432 and AB, GH in the third disk 433 are parity block checks. The parity block checks are distributed into each disk of the array, so as to reduce burden of various disk and act as backup. If one of the disks is damaged, then the lost data in the damaged disk is rebuilt through XOR calculation between the data in the other two disks and the parity block check. For example, if the third disk 433 fails and is replaced with a backup disk 433′ (as shown in FIG. 4B), blocks A, B, C, D, E, F, G, H, I and J of the data stream 41 are provided from the first disk 431 and the second disk 432. As shown in FIG. 4C, in order to rebuilt the data in the spare disk 433′, the RAID control unit 42 may read and perform XOR calculation of the data and parity block in the first disk 431 and the second disk 432. Rebuilding the data block of the spare disk 433″ still requires access of the other two working disks repeatedly, which may similarly result in low efficiency and I/O resource waste.

The above-discussed RAID systems are the core concept of the multiple RAIDs, but in view of different applications such as the amount of access, fault tolerance rate, performance efficiency and I/O resource usage, more RAID systems are produced, such as RAID 10, RAID 30, RAID 50.

However, there is a basic problem that exists in all of the above systems, that is, when a disk fails and needs to be replaced, whether the staff can cooperate immediately is of consideration. Additionally, when rebuilding the lost data, system availability may be affected by the low efficiency and frequent I/O data access that are caused by operating the system in the degraded mode.

Accordingly, there exists a strong need in the art for a method for establishing more stable and easily maintained data storage and protection mechanism to solve the drawbacks of the above-described conventional technology

### SUMMARY OF THE INVENTION

Accordingly, it is an objective of the present invention to provide a method for establishing a stable storage mechanism that allows redundant disks to be created dynamically for data backup.

It is another objective of the present invention to provide a method for establishing a stable storage mechanism that enhances efficiency during backup by allowing backup to be performed dynamically in advance of an actual disk failure.

It is yet another objective of the present invention to provide a method for establishing a stable storage mechanism that demands less I/O resources during backup.

It is a further objective of the present invention to provide a method for establishing a stable storage mechanism which can be applied in storage units with different disk interface specifications (e.g., ATA interface disk drive).

In order to attain the object mentioned above and the others, a method for establishing a stable storage mechanism applicable to a computer device with a RAID array and a RAID control unit is provided according to the present invention. The storage unit can be an ATA (Advanced Technology Attachment) interface disk drive, a Serial ATA interface disk drive or a SCSI (Small Computer System Interface) disk drive. The RAID control unit is used for performing a data protection mechanism immediately when learning from a disk detecting tool that the storage unit may fail in the near future. The disk detecting tool performs monitoring of physical properties of various disks, then issues a warning for a disk that is possible to fail to trigger a dynamic mirroring RAID mechanism (RAID 1) through amending a script file of the RAID control unit, thereby avoiding the lowering of performance efficiency of the RAID due to the degraded mode, and data lost can be reduced.

The method for establishing a stable storage mechanism according to the present invention firstly employs the disk detecting tool to monitor the operating condition of the disks in the storage unit, and if a warning or dangerous status of a disk is detected, the RAID control unit is actuated to execute the dynamic mirroring RAID backup technique, so as to mirror the data stored in the disk that is detected to possibly fail in the near future into a spare disk, and dynamically enter to the present storage structure (whether the storage unit is RAID structure or not does not affect the operation), thereby achieving fault-tolerance backup.

The above-discussed storage unit can be a storage unit with a RAID and a storage unit without a RAID. The storage unit without a RAID is one of storage unit with a single disk and or a plurality of disk; while the storage unit with a RAID can be nested-level RAID storage unit.

In one embodiment, when the method of the present invention is applied to the storage unit with a single disk, if the disk detecting tool has detected a warning status of a disk, then disk data protection mechanism is triggered to dynamically form a mirroring (RAID 1) array comprising a spare disk and the disk that has the warning status, so as to mirror all of the data in that disk to the spare disk. If external data is to be written during the mirroring operation, this data will be written into the spare disk as well as the disk that has the warning status. Thus, data can be prevented from losing if the disk in question actually fails. The spare disk will take over the operation of the original disk after finishing the mirroring operation. This mirroring operation occurs transparent to users, who merely require drawing out the damaged disk and substituting it with a normal disk without rebooting the system.

In another embodiment, when the method of the present invention is applied to the storage unit with a plurality of disk, the procedures are similar to those with the storage unit with one single disk. The difference is in that disk detecting tool can detect operating conditions of the multiple disks, and dynamically establish a mirroring RAID for any disk when warning occurs, so as to protect the data stored in the disks.

In addition, the method of the present invention can be applied to a storage unit with a RAID, if the disk detecting tool detects that a certain disk in the RAID storage unit may possibly fail. A mirroring (RAID 1) array is formed dynamically including the spare disk and the disk in question, so as to mirror all of the data in that disk into the spare disk. During mirroring, if external data is to be written into the disk in question, then data is written into the spare disk as well as the disk in question; if the external data is to be written to a disk that is not in question (no warning associated with it), then data will be written into that disk normally.

Therefore, the method for establishing a stable storage mechanism of the present invention can dynamically establishes a mirroring RAID to maintain normal operation for system with a RAID or without a RAID. Accordingly, by virtue of the method according to the present invention, the storage unit does not need to operate in a degraded mode and frequently accessed during rebuilding of data, providing dynamic, safe and efficient dynamic backup.

### BRIEF DESCRIPTION OF DRAWINGS

FIG. 1A (PRIOR ART) depicts a read/write schematic diagram of the data in the conventional RAID 0 system.

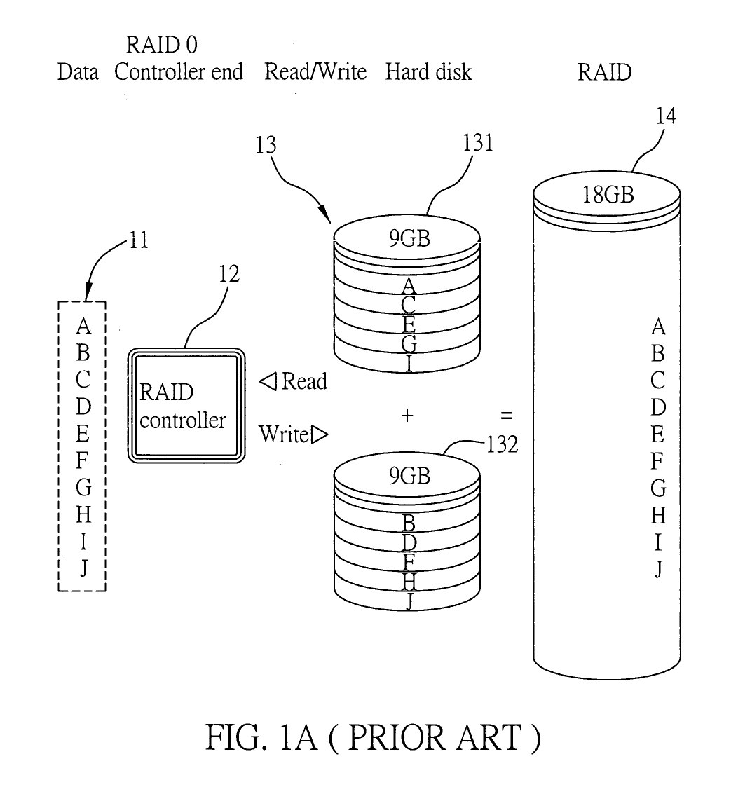

FIG. 1B (PRIOR ART) depicts a schematic diagram after the second disk is damaged in the conventional RAID 0 system.

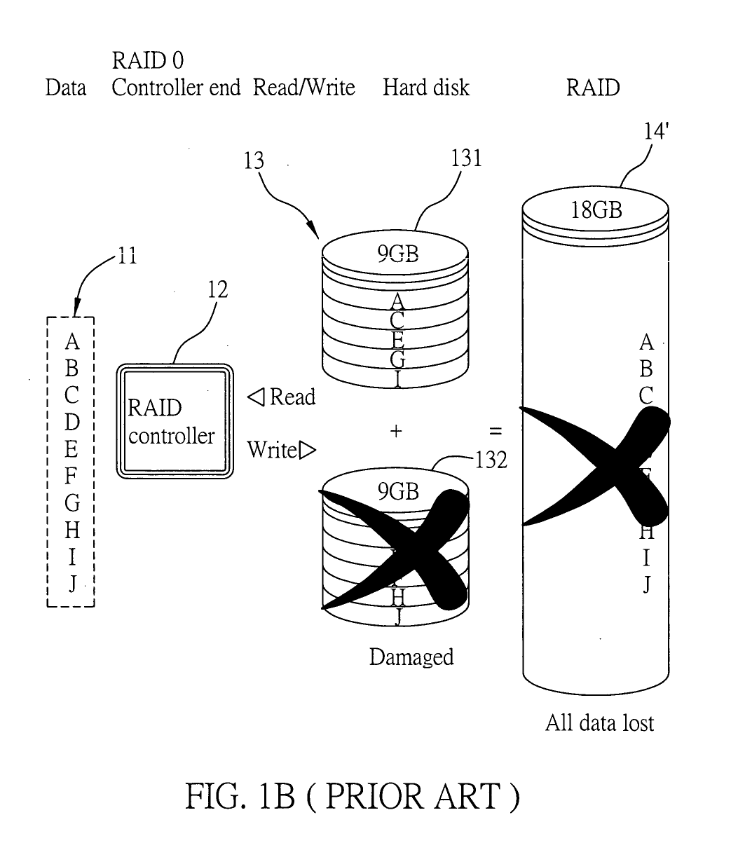

FIG. 2A (PRIOR ART) depicts a read/write schematic diagram of the data in the conventional RAID 1 system.

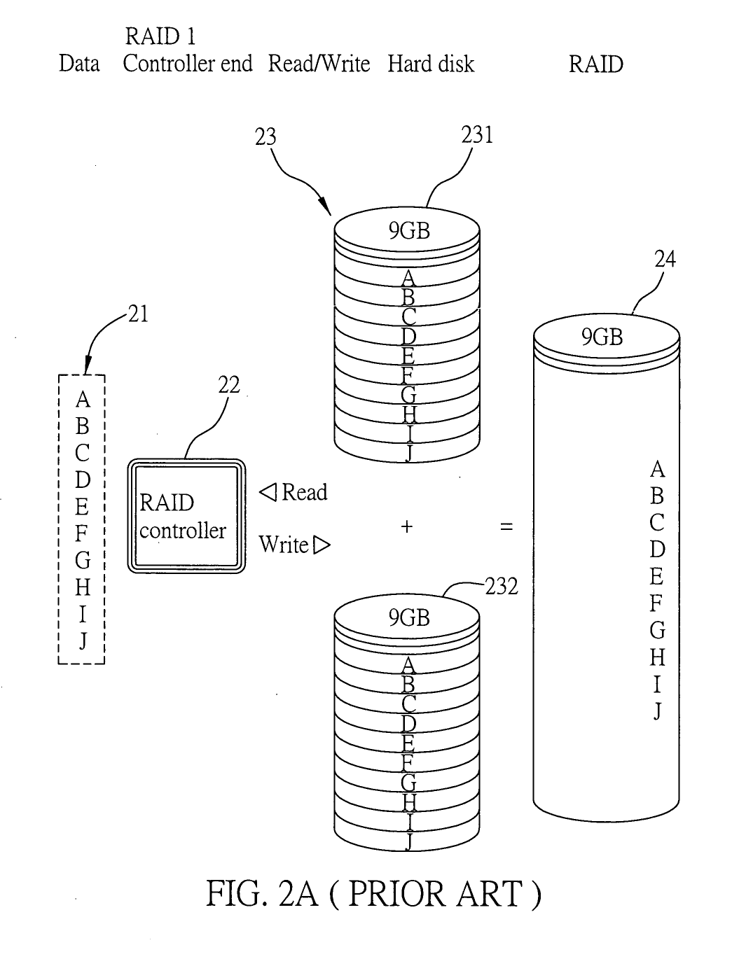

FIG. 2B (PRIOR ART) depicts a schematic diagram after the second disk is damaged in the conventional RAID 1 system.

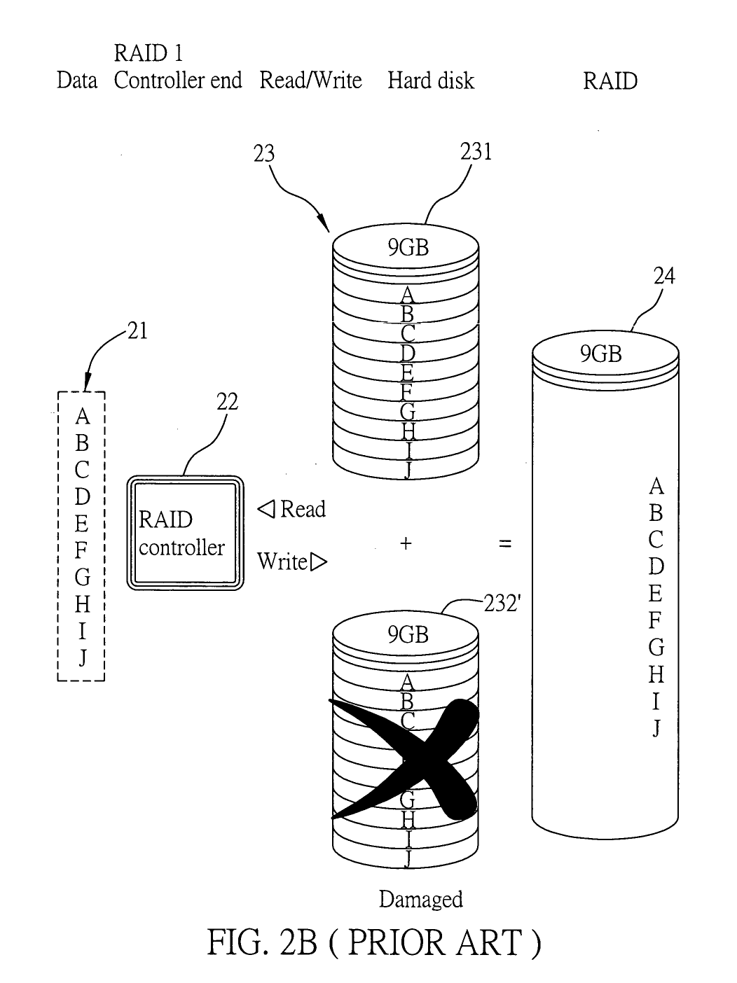

FIG. 2C (PRIOR ART) depicts a schematic diagram illustrating rebuilding of data after the damaged disk is replaced with a new disk in the conventional RAID 1 system.

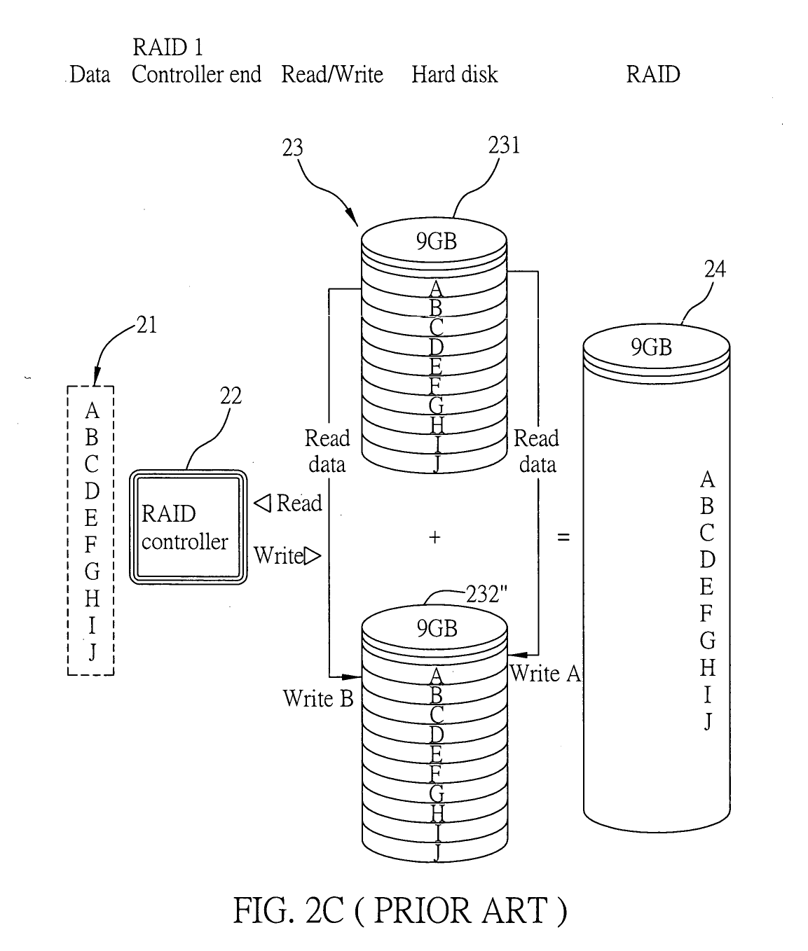

FIG. 3A (PRIOR ART) depicts a read/write schematic diagram of the data in the conventional RAID 0+1 system.

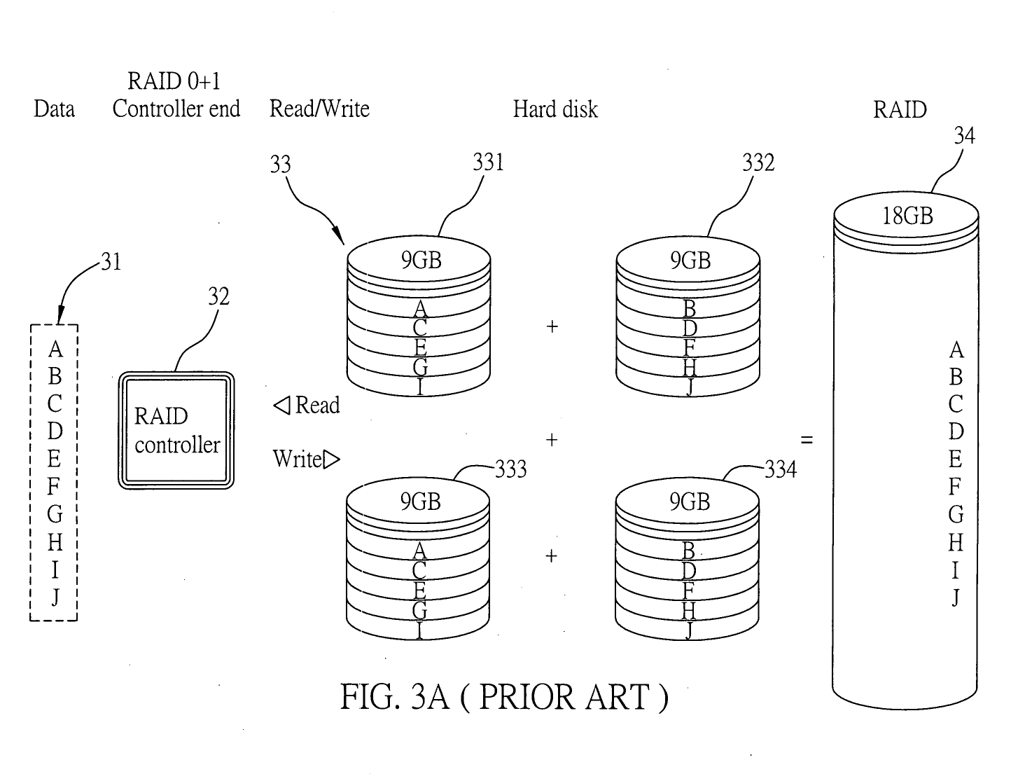

FIG. 3B (PRIOR ART) depicts a schematic diagram after the third disk is damaged in the conventional RAID 0+1 system.

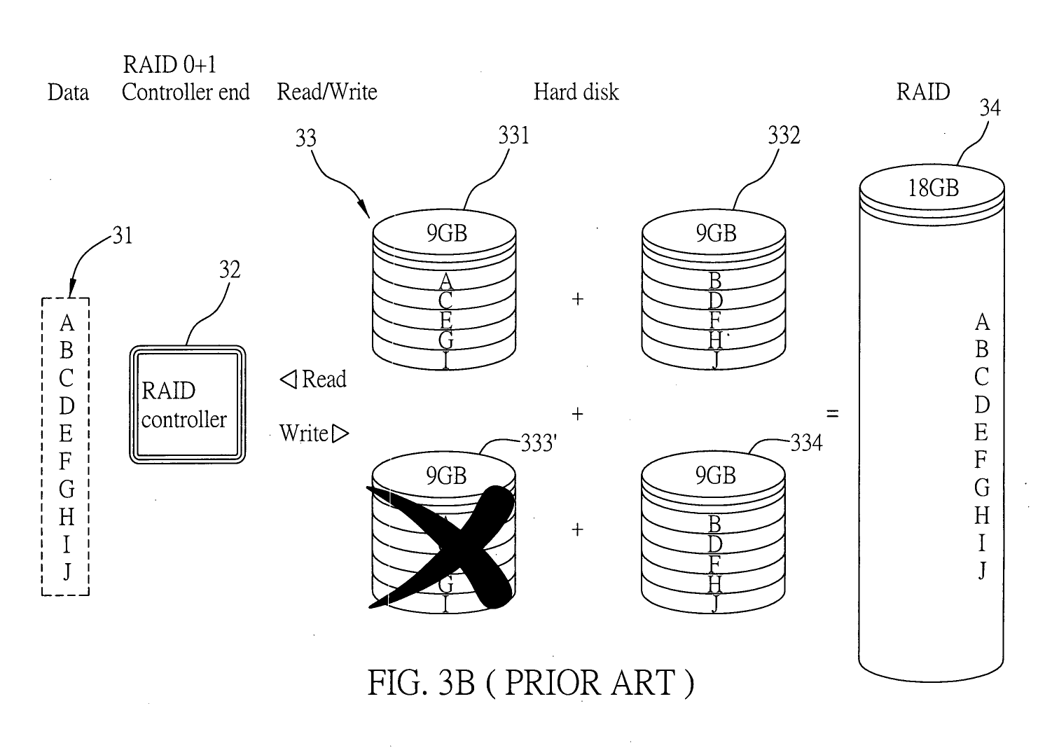

FIG. 3C (PRIOR ART) depicts a schematic diagram illustrating rebuilding of data after the damaged disk is replaced with a new disk in the conventional RAID 0+1 system.

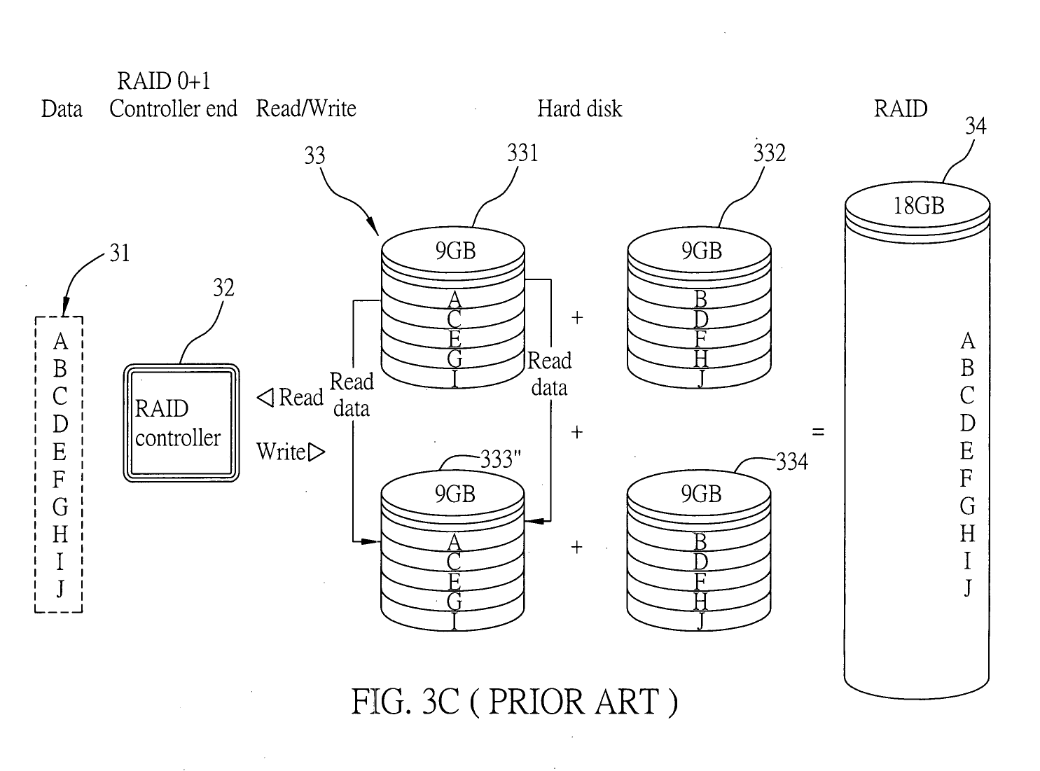

FIG. 4A (PRIOR ART) depicts a read/write schematic diagram of the data in the conventional RAID 5 system.

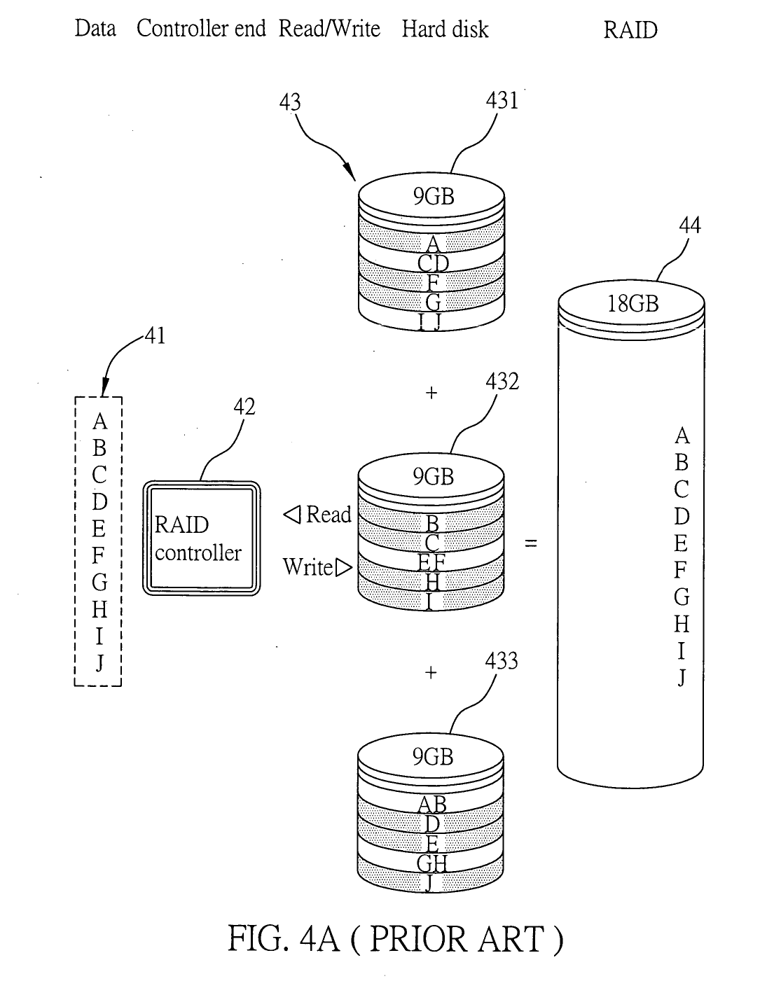

FIG. 4B (PRIOR ART) depicts a schematic diagram after the third disk is damaged in the conventional RAID 5 system.

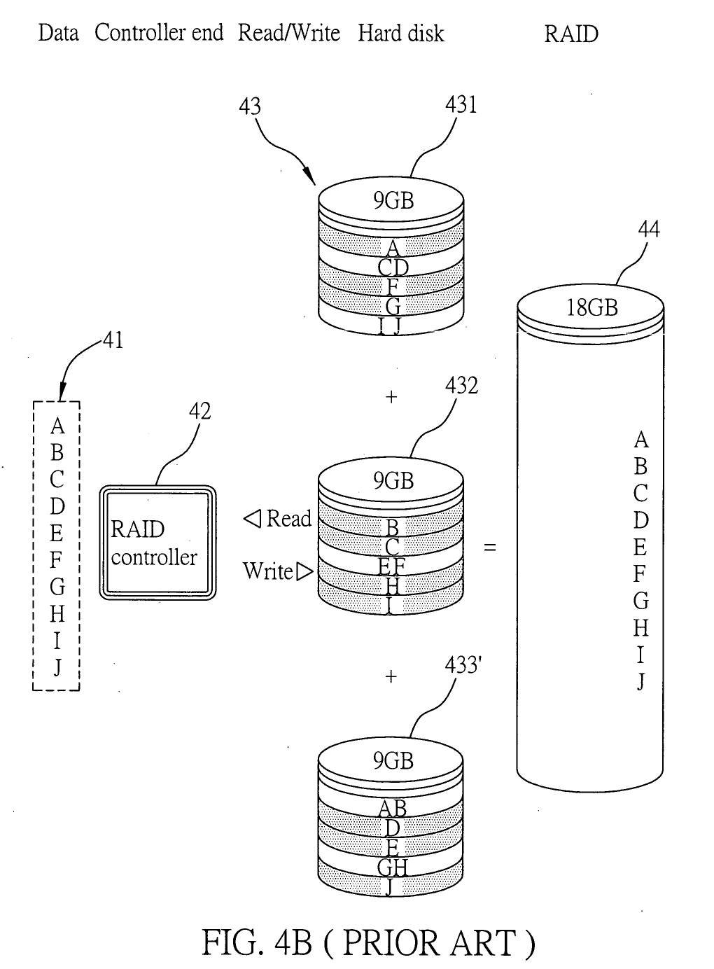

FIG. 4C (PRIOR ART) depicts a schematic diagram illustrating rebuilding of data after the damaged disk is replaced with a new disk in the conventional RAID 5 system.

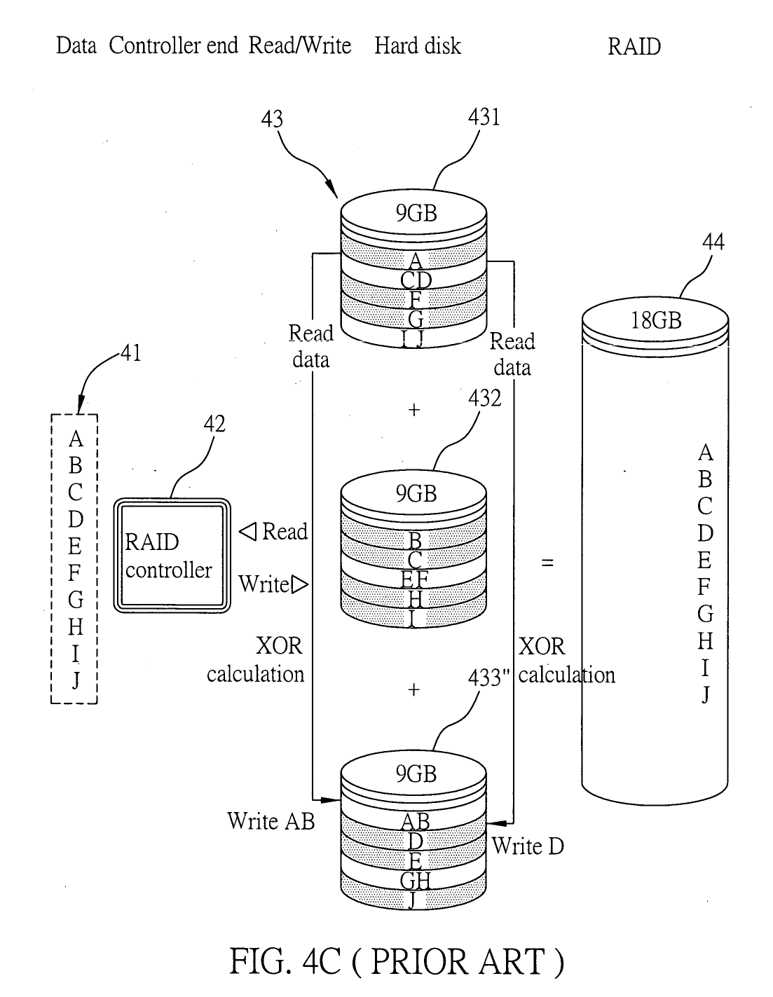

FIG. 5 depicts an operation flow of the disk detecting tool according to the method for establishing a stable storage mechanism of the present invention.

FIG. 6 depicts a schematic diagram illustrating disk backup implemented in the RAID 0 system according to the method for establishing a stable storage mechanism of the present invention.

FIG. 7 depicts a schematic diagram illustrating disk backup implemented in the RAID 1 system according to the method for establishing a stable storage mechanism of the present invention.

FIG. 8 depicts a schematic diagram illustrating disk backup implemented in the RAID 0+1 system according to the method for establishing a stable storage mechanism of the present invention.

FIG. 9 depicts a schematic diagram illustrating disk backup implemented in the RAID 5 system according to the method for establishing a stable storage mechanism of the present invention.

FIG. 10 depicts a schematic diagram illustrating disk backup implemented in the storage unit without a RAID according to the method for establishing a stable storage mechanism of the present invention.

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification. The present invention can also be performed or applied by other different embodiments. The details of the specification may be on the basis of different viewpoints and applications, and numerous modifications and variations can be devised without departing from the spirit of the present invention.

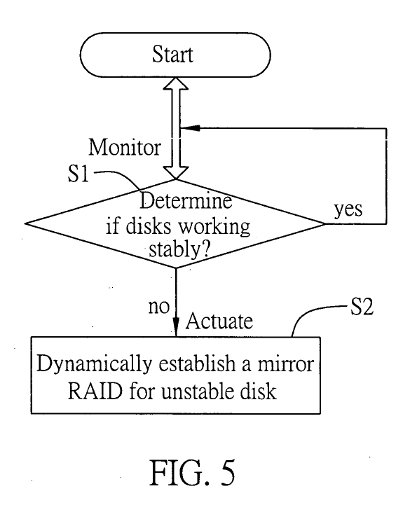

With reference to FIG. 5, shown is a flow chart for detecting disk condition by a disk detecting tool according to the method for establishing a stable storage mechanism of the present invention. As described more fully below, the method for establishing a stable storage mechanism according to the present invention first employs the disk detecting tool (the disk detecting tool is a conventional tool, such as SMART, Bad sector recovery and the like, so it will not be further described) to detect operating condition of disks contained in a computer device, so as to determine whether the current disks are operating normal or not, if not, proceed to step S2, if yes, return to step S1, the condition of each disk is monitored continuously.

At step S2, when determining that a disk is in a warning or dangerous state, a script file of a RAID control unit is amended to change the structure of the RAID storage unit and establish a redundant RAID array, so as to establish a dynamic RAID system for the abnormal disk to prevent sudden failure.

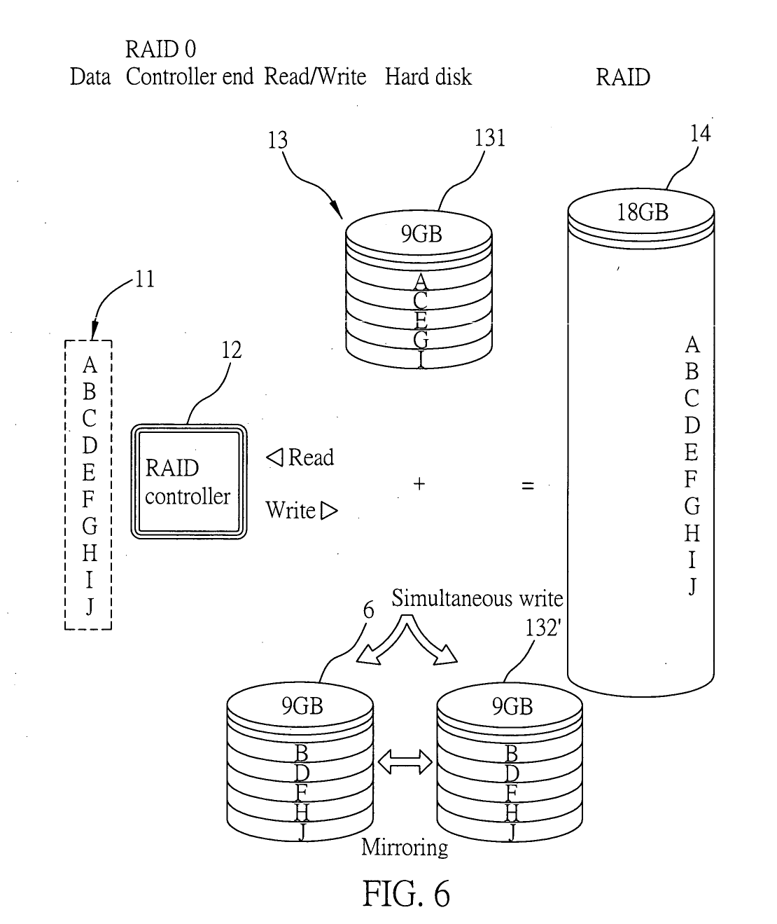

With reference to FIG. 6, shown is an exemplary embodiment of the method for establishing a stable storage mechanism of the present invention applied to a RAID 0 system. In the exemplary embodiment, when the second disk 132′ is in a warning or dangerous state, the disk detecting tool (not illustrated) immediately actuate the RAID control unit 12 (which includes the abilities of forming the mirroring RAID array and executing read/write of the mirroring RAID array) to execute a dynamic mirroring RAID program, so as to perform a backup of the system data of the second disk 132′ with fault in doubt to a dynamic redundant disk 6 before it actually fails.

The approach of this dynamic mirroring includes first amending the script file of the RAID control unit 12, thereby making the dynamic redundant disk 6 and the second disk 132′ with fault in doubt to form a mirroring RAID array. If a data stream 11 is to be stored into the second disk 132′, the data stream 11 is written via the RAID control unit 12 into both the dynamic redundant disk 6 and the second disk 132′ with fault in doubt simultaneously. On the other hand, if the data is to be stored in the first disk 131, normal write operation is performed to store data into the first disk 131. When there is no data read/written from/to the second disk 132′ with fault in doubt, the dynamic redundant disk 6 and the second disk 132′ with fault in doubt are to execute disk mirroring by the RAID control unit 12, and the dynamic redundant disk 6 will take over the I/O tasks once the mirroring is completed. Accordingly, the method for establishing a stable storage mechanism according to the present invention dynamically addresses the problem of no redundancy provided by a RAID 0 system while reserving the simultaneous access of data.

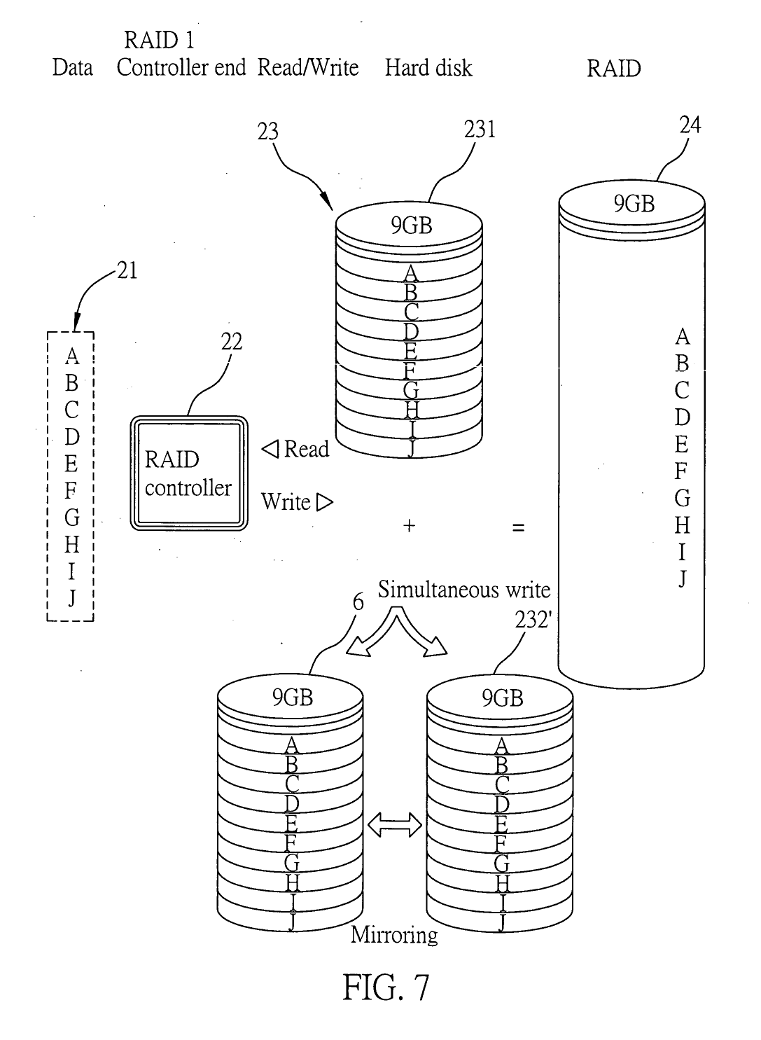

With reference to FIG. 7, shown is an exemplary embodiment of the method for establishing a stable storage mechanism of the present invention applied to a RAID 1 system. In the exemplary embodiment, when the second disk 232′ is in a warning or dangerous state, the disk detecting tool (not illustrated) immediately actuate the RAID control unit 22 to execute the dynamic mirroring, so as to perform a backup of the system data of the second disk 232′ with fault in doubt to a dynamic redundant disk 6 before it actually fails.

Similarly to the previous example, the dynamic mirroring includes first amending the script file of the RAID control unit 22, thereby making the dynamic redundant disk 6 and the second disk 232′ with fault in doubt to form a mirroring RAID array. If a data stream 21 is to be stored into the second disk 232′, the data stream 21 is written via the RAID control unit 22 into both the dynamic redundant disk 6 and the second disk 232′ with fault in doubt simultaneously. On the other hand, if the data is to be stored in the first disk 231, normal write operation is performed to store data into the first disk 231. When there is no data read/written from/to the second disk 232′ with fault in doubt, the dynamic redundant disk 6 and the second disk 232′ with fault in doubt are to execute disk mirroring by the RAID control unit 22, and the dynamic redundant disk 6 will take over the I/O tasks once the mirroring is completed. Accordingly, the method for establishing a stable storage mechanism according to the present invention dynamically and automatically executes data backup when detecting that a fault is possibly going to occur in a disk to avoid replacing and rebuilding the disk only after it fails

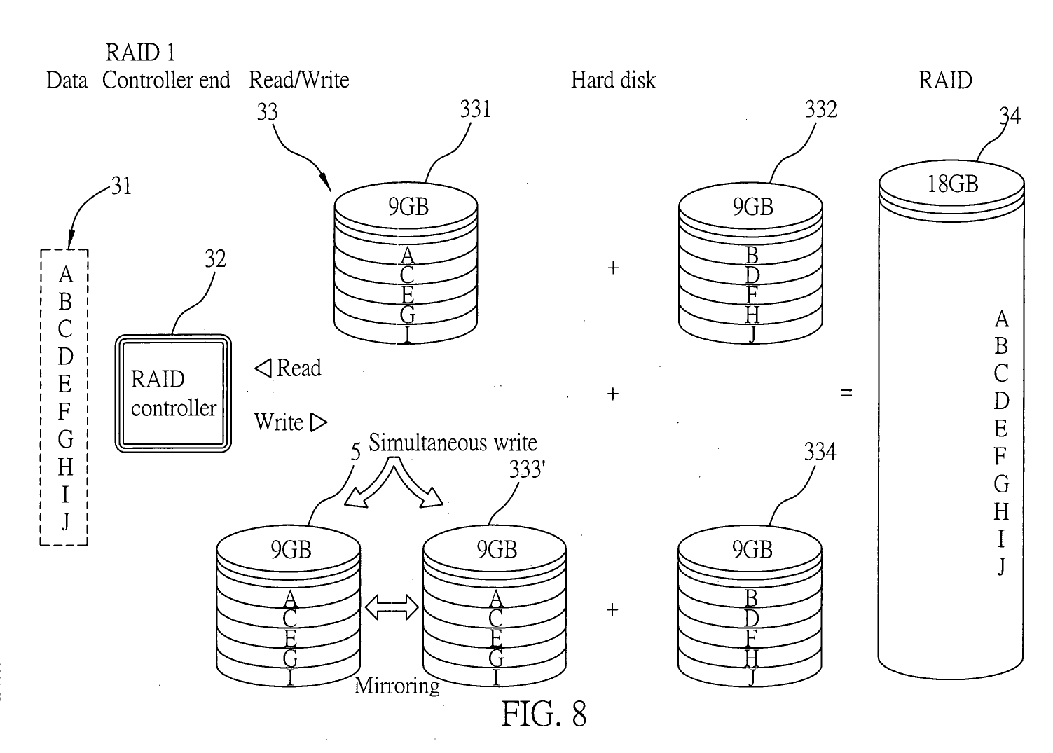

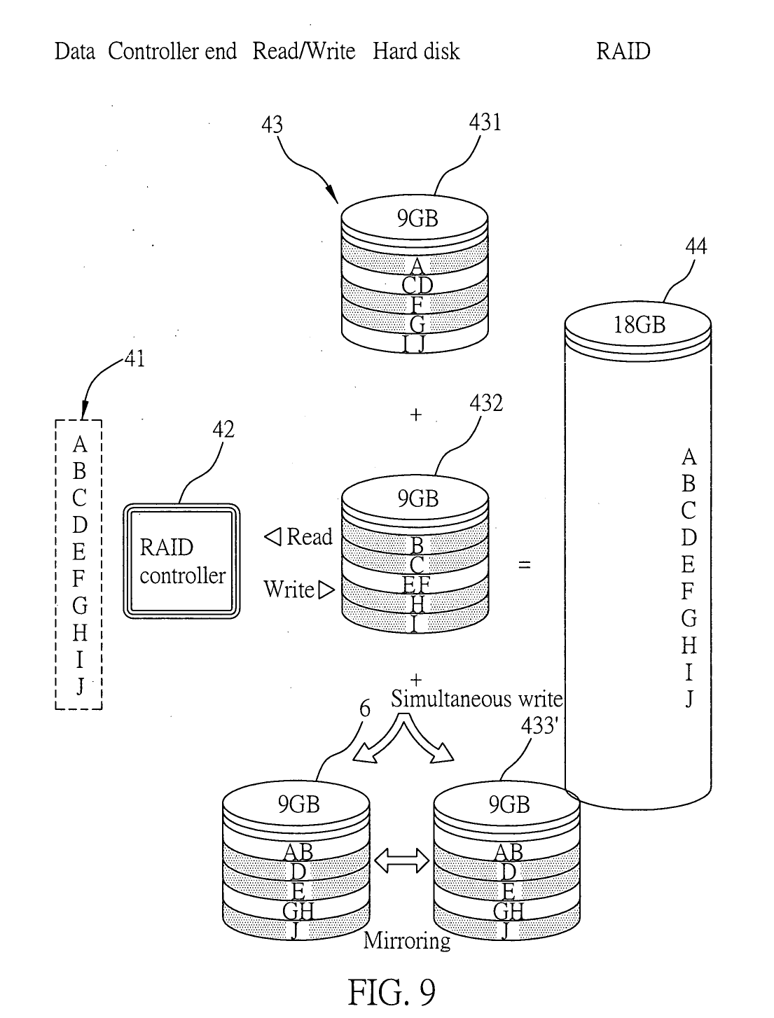

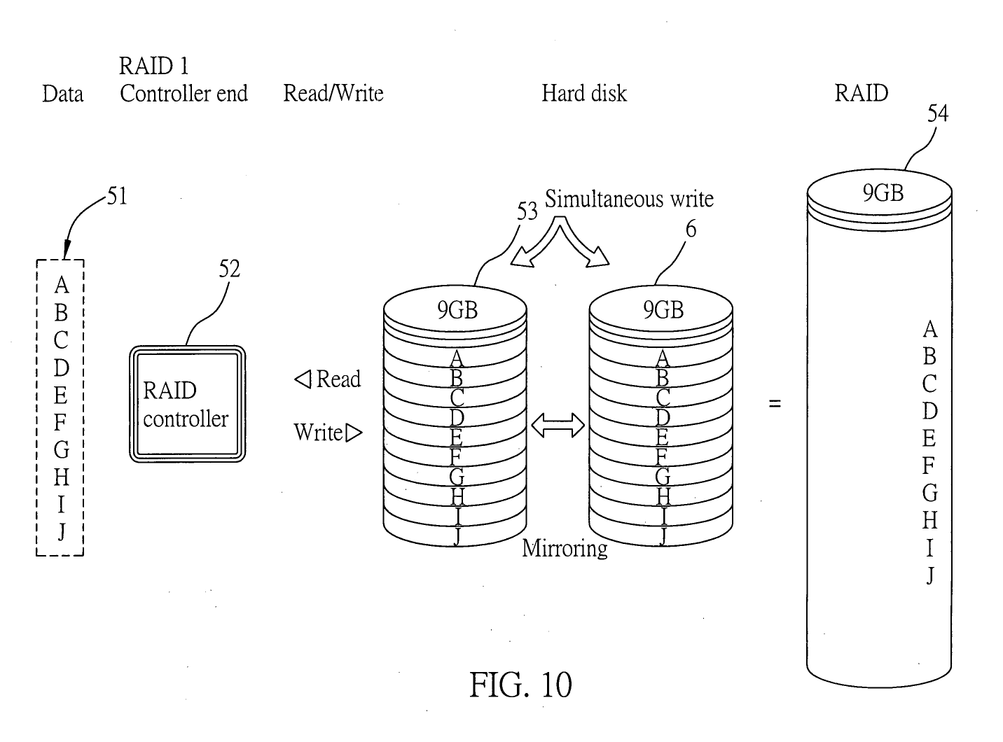

FIGS. 8, 9 and 10 show exemplary embodiments of the method for establishing a stable storage mechanism of the present invention applied to a RAID 0+1 system, a RAID 5 system and a non-RAID system, respectively. In these embodiments, the data can be dynamically backup when a disk is suspected to fail in the near future in a way similar to the abovementioned dynamic mirroring procedures, so they will not be further illustrated.

Accordingly, the method for establishing a stable storage mechanism according to the present invention allows dynamic backup to be performed in advance of a disk failure by monitoring the operating conditions of the disks and dynamically creating a redundant disk, so that users should not need to wait for an actual disk failure to upgrade the problematic disks, thereby eliminating significant decrease in efficiency and large I/O access during the degraded mode of the prior art.

What described above is the preferred embodiment of the present invention as illustrative, but it is not to limit the scope of the present invention, i.e., other changes in deed can be implemented in the, present invention, accordingly, all modifications and variations completed by those skilled in the art according to the spirit and technical principle in the disclosure of the present invention should fall within the scope of the appended claims.

What is claimed is:

1. A method for establishing a stable storage mechanism applicable to a storage unit with a control unit, comprising:
detecting operating condition of at least one disk in the storage unit and outputting a status selected from the group consisting of a normal status and an unstable status based on the detected operation condition of the at least one disk; and
when the status of the at least one disk is determined to be unstable, dynamically mirroring data stored in the unstable disk into a dynamic redundant disk by the control unit.

2. The method for establishing a stable storage mechanism of claim 1, wherein the step of mirroring further includes:
amending a script file of the control unit to dynamically establishing the dynamic redundant disk in the storage unit;
forming a mirroring disk array composed of the dynamic redundant disk and the unstable disk;
mirroring data stored in the unstable disk into the dynamic redundant disk when no data access thereto, and simultaneously writing data into the dynamic redundant disk and the unstable disk when data is written thereto; and
allowing the dynamic redundant disk to take over after completing mirroring.

3. The method for establishing a stable storage mechanism of claim 1, wherein detecting operating condition of the at least one disk is performed by a tool with SMART (Self-Monitoring Analysis and Reporting Technology).

4. The method for establishing a stable storage mechanism of claim 1, wherein the storage unit is one of a ATA (Advanced Technology Attachment) interface disk drive, a Serial ATA interface disk drive and a SCSI (Small Computer System Interface) disk drive.

5. The method for establishing a stable storage mechanism of claim 1, wherein the storage unit is one of a storage unit without a RAID and a storage unit with a RAID.

6. The method for establishing a stable storage mechanism of claim 5, wherein the storage unit without a RAID is one of a storage unit with a single disk drive and a storage unit with a plurality of disk drives.

7. The method for establishing a stable storage mechanism of claim 5, wherein the storage unit with a RAID is one of RAID 0, RAID 1, RAID 0+1, RAID 2, RAID 3, RAID 4, RAID 5, RAID 6, RAID 7, RAID 10, RAID 30 and RAID 50.

8. The method for establishing a stable storage mechanism of claim 2, wherein the script file is a file that can be changed to dynamically change the structure of the storage unit.
